(19) United States
(12) Patent Application Publication
(10) Pub. No.: US 2025/0143254 A1
(43) Pub. Date: May 8, 2025

(54) BEDDING, COMPOST AND METHOD FOR PRODUCING COMPOST

(71) Applicant: ASAHI GROUP HOLDINGS, LTD., Tokyo (JP)

(72) Inventors: Tetsuya ISHIDA, Ibaraki (JP); Takeshi Shirai, Ibaraki (JP); Kazuya Iwasaki, Miyazaki (JP)

(73) Assignee: ASAHI GROUP HOLDINGS, LTD., Tokyo (JP)

(21) Appl. No.: 19/018,184

(22) Filed: Jan. 13, 2025

Related U.S. Application Data
(63) Continuation of application No. 16/960,623, filed on Jul. 8, 2020.

(30) Foreign Application Priority Data
Mar. 23, 2018 (JP) 2018-056371

(51) Int. Cl. A01K 1/015; C05F 3/00; C05F 17/10

(52) U.S. Cl. CPC A01K 1/0155; A01K 1/015; C05F 3/00; C05F 17/10

(57) ABSTRACT

A novel livestock bedding and a novel compost. A livestock bedding to be used for rearing livestock, said livestock bedding comprising a shredded product of a plant belonging to a genus Erianthus.

### TECHNICAL FIELD

The present invention relates to a bedding, and in particular, to a bedding for domestic animals used for rearing domestic animals.

### BACKGROUND ART

In rearing farms for domestic animals, domestic animals are bred on a bedding spread in the rearing area of domestic animals. For this bedding for domestic animals, woody feedstocks such as sawdust and bark have been mainly used. However, in recent years, due to the competition of use with woody pellets (fuel) and others, the price rise and supply shortage of woody feedstocks occur, and for the bedding, even old paper and gypsum board have come to be utilized. While old paper has a high cushioning property and absorbability, it has a low water retaining property. Therefore, when load is applied on old paper, the absorbed water seeps out, and if it is left to stand after absorbing water, it is solidified. For this reason, in order to use old paper as the bedding, it is necessary to mix woody feedstocks with old paper for compensating for its disadvantages, and old paper alone is not likely to be a complete substitute for woody feedstocks. In addition, since gypsum board does not biodegrade, it is difficult to reuse it as a compost or the like after it is used as the bedding.

Gramineous plants are monocotyledonous plants of angiosperms, and have been investigated for use for a variety of applications up to date. For example, Patent Literature 1 discloses a bedding in which rice straw (a gramineous plant) is added to coffee grounds. Patent Literature 2 discloses an organic fermented fertilizer using rice husks obtained from a gramineous plant. Patent Literature 3 discloses a fermented organic compost using rice husks of rice straw (a gramineous plant) and coffee extraction residues. Patent Literature 4 discloses a fermented organic fertilizer using bran obtained from rice (a gramineous plant). Patent Literature 5 discloses an organic fermented fertilizer formed by fermenting rice straw (a gramineous plant) with two unique bacterial species.

Gramineous plants are classified into about 700 genera, and gramineous plants classified in each genus have different forms and natures from each other. In about 700 genera included in gramineous plants, plants of the genus Erianthus are included, and the plants of the genus Erianthus have been used as, for example, a pellet fuel (Non Patent Literature 1) and as a cellulosic biomass feedstock (Patent Literature 6). In addition, a method for purifying the soil by planting a plant of the genus Erianthus in oil contaminated soil (Patent Literature 7) is also known.

### CITATION LIST

### Patent Literature

### Patent Literature 1

JP 2009-148304A

### Patent Literature 2

JP 2008-50248A

### Patent Literature 3

JP 11-228266A

### Patent Literature 4

JP 2002-68879A

### Patent Literature 5

JP 10-251087A

### Patent Literature 6

JP 2016-96751A

### Patent Literature 7

JP 2015-44190A

### Non Patent Literature

### Non Patent Literature 1

“Ecological Fuel Erianthus Grown in Field, ‘JES1’ Cultivation, Utilization of Abandoned Land→Pelletization→CO₂ Reduction”, THE JAPAN AGRICULTURAL NEWS, Nov. 11, 2017

### SUMMARY OF INVENTION

### Technical Problem

Patent Literatures 1 to 7 and Non Patent Literature 1 do not disclose any beddings for domestic animals or composts using a gramineous plant of a particular genus.

An object of the present invention is to provide a novel bedding for domestic animals and a novel compost.

### Solution to Problem

The gist of the present invention is as follows:
[1] A bedding for domestic animals used for rearing domestic animals, wherein the bedding for domestic animals comprises a shredded product of a plant of a genus Erianthus.
[2] The bedding for domestic animals according to [1], wherein the bedding for domestic animals has a bulk density of 50 kg/m³ or more and 200 kg/m³ or less.
[3] A compost comprising a fermented product of a shredded product of a plant of a genus Erianthus.
[4] The compost according to [3], wherein the fermented product is a fermented product of the shredded product to which excretion have been attached.
[5] A method for producing a compost, comprising fermenting a shredded product of a plant of a genus Erianthus.
[6] The method for producing a compost according to [5], wherein the shredded product is fermented after excretion are attached to the shredded product.
[7] The method for producing a compost according to [6], wherein excretion of domestic animals are attached to the shredded product by rearing domestic animals using the shredded product.

### Advantageous Effects of Invention

According to the present invention, a novel bedding for domestic animals and a novel compost can be provided.

### BRIEF DESCRIPTION OF DRAWINGS

FIG. 1 is a graph showing the concentration of ammonia.

FIG. 2 is a graph showing the score of footpad dermatitis.

FIG. 3 is a graph showing the rearing rate.

FIG. 4 is a graph showing the germination rate.

FIG. 5 is a photograph showing the germination state.

FIG. 6 is a graph showing the concentration of ammonia.

FIG. 7 is a graph showing the hardness.

FIG. 8 is a graph showing the rearing rate.

FIG. 9 is a graph showing the feed conversion rate.

FIG. 10 is a graph showing the production score.

FIG. 11 is a graph showing the relationship between the bulk density and the water absorbing capacity.

FIG. 12 is a graph showing measurement results pertaining to the cushioning property.

FIG. 13 is a graph showing the relationship between the bulk density and the cushioning degree.

### DESCRIPTION OF EMBODIMENTS

Hereinafter, an embodiment of the present invention will be described in detail.

At first, a bedding for domestic animals of the present embodiment will be described.

The bedding for domestic animals of the present embodiment is a bedding used for rearing domestic animals. The bedding for domestic animals of the present embodiment is, for example, spread in the rearing area of domestic animals for use, and domestic animals are bred on the bedding for domestic animals spread in the rearing area. Note that the domestic animals in the present embodiment mean animals bred by humans, and examples thereof may include chickens, pigs and cows.

The bedding for domestic animals of the present embodiment comprises a shredded product of a plant of the genus Erianthus (Erianthus spp.) (hereinafter, also simply referred to as a “shredded product”).

Plants of the genus Erianthus are gramineous perennial plants, and have excellent desiccation resistance, reproducibility (germination ability) and low fertilizer requirement. Examples of the plant of the genus Erianthus may include Erianthus arundinaceus, Erianthus procerus, Erianthus longesetosus and Erianthus ravennae. The plants of the genus Erianthus can be used in the bedding for domestic animals of the present embodiment regardless of their growth regions.

From the viewpoint of facilitating the creation of an environment suited for rearing domestic animals, it is preferable to use Erianthus arundinaceus as the plant of the genus Erianthus. Moreover, it is also preferable to use Erianthus arundinaceus from the viewpoint of suppressing the price rise and supply shortage of the bedding because Erianthus arundinaceus can be produced with a higher biomass quantity (total amount that can be produced in a particular area during a particular period of time) compared to gramineous plants classified into genera other than the genus Erianthus.

The shredded product included in the bedding for domestic animals of the present embodiment is a plant of the genus Erianthus made finer (shredded) by performing a physical treatment such as cutting or pulverization on the plant of the genus Erianthus. The shredded product can be obtained by making a plant of the genus Erianthus finer (shredding a plant of the genus Erianthus), using, for example, a sawdust powder making machine, a cutting apparatus or a shredding machine.

The shredding condition of a plant of the genus Erianthus is not particularly limited and can be selected as appropriate, but it is preferable to shred the plant of the genus Erianthus such that the bulk density of the shredded product is, for example, 50 kg/m³ or more and 200 kg/m³ or less. When the bulk density of the shredded product is within the range of 50 kg/m³ or more and 200 kg/m³ or less, it is easier for the bedding for domestic animals of the present embodiment to create an environment that is more suited for the growth of domestic animals compared to the case where the bulk density of the shredded product is outside that range. It is believed that, while the surface area is increased and the coefficient of water absorption is improved when the bulk density of the shredded product becomes higher, the air permeability is decreased, thereby worsening the cushioning property and the like when the bulk density is too high. For this reason, it is preferable to set the bulk density to an appropriate range such as the range mentioned above (50 kg/m³ or more and 200 kg/m³ or less). Note that the bulk density is the mass per unit volume, which is the value obtained by dividing the mass of the shredded product by the volume including the voids between the shredded product.

For the shredded product, any site of the stems, leaves and roots of the plant of the genus Erianthus may be used. However, since the stems and leaves grow again if the roots are left when the plant of the genus Erianthus is harvested, in consideration of repeated harvesting, it is preferable to use only the above ground parts (stems and leaves) that are exposed from the ground surface. Also, the plant of the genus Erianthus to be shredded may be harvested at any growth stage. For example, it may be harvested during the vegetative growth stage when the stems and leaves spread and grow, it may be harvested during the reproductive stage when the reproductive activity of leaving offspring is performed, or it may be harvested during the withering and dying stage (resting stage) when the stems and leaves wither and die. In addition, the plant of the genus Erianthus may be dried before or after shredding. The moisture content of the shredded product is not particularly limited and can be set as appropriate.

The bedding for domestic animals of the present embodiment may be constituted with the shredded product alone, but may also include another material in addition to the shredded product. Examples of the other material may include, in addition to woody feedstocks such as sawdust (sawdust powder) and bark, straw (rice straw, wheat straw and the like (except for plants of the genus Erianthus)), rice husks, waste mushroom beds, tea grounds, pruned branches and leaves, bagasse, coffee grounds, water absorbing polymers, fully matured compost, recycled paper, gypsum board, and porous substances (activated carbon, zeolite and the like). In the bedding for domestic animals of the present embodiment, the content ratio of the shredded product and the other material is not particularly limited and can be set as appropriate.

The form of the bedding for domestic animals of the present embodiment is not particularly limited as long as it can be spread in the rearing area of domestic animals. For example, the bedding for domestic animals of the present embodiment may be simply a collection of the shredded product (or the shredded product and the other material), or it may be molded into a certain shape by compressing the shredded product (or the shredded product and the other material), for example.

The bedding for domestic animals of the present embodiment can be produced by shredding the plant of the genus Erianthus to obtain the shredded product. In addition, when the bedding for domestic animals of the present embodiment contains a material other than the shredded product, the bedding for domestic animals of the present embodiment can be obtained by mixing the shredded product with another material through stirring or the like, or by stacking the shredded product with another material. Furthermore, when the bedding for domestic animals of the present embodiment is made into a compression molded body, the bedding for domestic animals of the present embodiment can be obtained by compressing the shredded product (or the shredded product and the other material) at a certain pressure.

For conventional beddings for domestic animals, woody feedstocks such as sawdust and bark have been mainly used. However, woody feedstocks are byproducts obtained from building materials and the like, and therefore, there is a limitation on the supply. In addition, due to the competition of use with woody pellets (fuel) and others, the price rise and supply shortage of woody feedstocks occur. On the other hand, in the bedding for domestic animals of the present embodiment, the shredded product of the plant of the genus Erianthus is used. Plants of the genus Erianthus have excellent desiccation resistance, reproducibility (germination ability) and low fertilizer requirement, and therefore, they are easily cultivated and are also excellent in the growth efficiency. For this reason, plants of the genus Erianthus can be acquired steadily in a large quantity. Accordingly, the cost of the bedding for domestic animals of the present embodiment is difficult to rise and the shortage of supply is unlikely to occur. In particular, since Erianthus arundinaceus can be produced with a higher biomass quantity (for example, 30 t/ha/year) compared to gramineous plants classified into genera other than the genus Erianthus. Thus, the cost of the bedding for domestic animals using Erianthus arundinaceus is further difficult to rise and the shortage of supply is further unlikely to occur.

In addition, the bedding for domestic animals of the present embodiment creates an environment suited for rearing domestic animals more easily compared to conventional beddings for domestic animals using woody feedstocks and the like. Specifically, in the bedding for domestic animals of the present embodiment, compared to conventional beddings for domestic animals, ammonia is less likely to be left on the surface of the bedding (shredded product) and the onset and progression of footpad dermatitis can be suppressed. Footpad dermatitis is an inflammation of the skin or subcutaneous tissue, occurring on the soles of chicken toes, and is caused by a bacterial infection arising from excessive ammonia or moisture included in the bedding. If domestic animals (chickens) develop footpad dermatitis, it may cause a decrease in the profitability of companies that collect toe parts for sale, and domestic animals (chickens) with the lesion may also exhibit limping, causing growth stagnation due to decreased locomotion and worsening the growth rate. In addition, the bedding for domestic animals of the present embodiment is less likely to cause death of domestic animals bred in the rearing area in which the bedding is spread, compared to conventional beddings for domestic animals.

Further, in an environment for rearing domestic animals, it is desired to prevent accumulation of moisture arising from excretion of domestic animals, spill of drinking water, rain water and the like in order not to cause footpad dermatitis or not to wet domestic animal bodies to lower their body temperatures, and the bedding for domestic animals preferably has a higher water absorbability. On the other hand, when the body pressure of domestic animals is applied to the bedding for domestic animals that has absorbed water and the absorbed water is released, moisture is accumulated in the bedding for domestic animals. Therefore, it is preferable that the bedding for domestic animals should have a high water retaining property in addition to a high water absorbability. The bedding for domestic animals of the present embodiment has a water absorbability that is equivalent to or greater than that of conventional beddings for domestic animals, and has a water retaining property that is higher than that of conventional beddings for domestic animals. Accordingly, the bedding for domestic animals of the present embodiment easily creates an environment suited for rearing domestic animals.

Next, a compost of the present embodiment will be described.

The compost of the present embodiment comprises a fermented product formed by fermenting a shredded product of a plant of the genus Erianthus. Note that the shredded product to be used for the compost of the present embodiment has the same configuration as that of the shredded product to be used for the bedding for domestic animals mentioned above, and a detailed description is thus omitted.

The fermented product included in the compost of the present embodiment is formed by fermenting the shredded product. In the present embodiment, fermentation means decomposition of organic matter into a state of being returnable to soil (a substance that is returnable to soil (for example, nitrogen, phosphoric acid and potassium)), and decomposition of organic matter into a state of being returnable to soil is also referred to as composting.

Fermentation of the shredded product may be carried out by microorganisms that have been attached to the harvested plant of the genus Erianthus (that is, microorganisms that have continued to be attached after shredding), or it may be carried out by microorganisms that are to be separately added to the shredded product. In addition, the fermentation of the shredded product may be carried out by aerobic microorganisms, or it may be carried out by anaerobic microorganisms. Examples of the microorganism that is to be attached to the plant of the genus Erianthus may include an actinomycete, a yeast, Bacillus subtilis and a Lactobacillus. Examples of the microorganism that is to be separately added may include a bacterium such as Bacillus subtilis and a Lactobacillus, a filamentous fungus, an actinomycete and a yeast.

The compost of the present embodiment may be constituted with the fermented product alone, which is formed by fermenting the shredded product, but may also include another material in addition to the fermented product. Examples of the other material may include a soil conditioner such as charcoal and diatomaceous earth. In the compost of the present embodiment, the content ratio of the fermented product and the other material is not particularly limited and can be set as appropriate.

The fermented product included in the compost of the present embodiment may be formed by fermenting the shredded product to which excretion have been attached. In excretion, organic matter containing a component that can be utilized for growing crops (nitrogen, phosphoric acid, potassium and the like) and a microorganism that carries out fermentation (E. coli and the like) are abundantly included. For this reason, by using the shredded product to which excretion have been attached as a raw material for the compost, while promoting fermentation of the shredded product, a compost abundantly including a component that can be utilized for growing crops can be obtained. In addition, organic matter (for example, ammonia) included in the excretion of domestic animals that is harmful to crops can be decomposed through fermentation of the shredded product. As the excretion to be attached to the shredded product, those of humans or animals can be used.

The compost of the present embodiment may be used by, for example, scattering it on the soil in which crops are grown, or mixing it into the soil in which crops are grown. In addition, the compost of the present embodiment can be extracted with water or hot water to obtain a liquid, and the extraction liquid can be used by pouring it on the soil in which crops are grown. Furthermore, the compost of the present embodiment can also be reused for the bedding for domestic animals as a recycled compost.

The compost of the present embodiment can be produced by fermenting the shredded product. The method for fermenting the shredded product may be any method as long as it can decompose organic matter contained in the shredded product into a state of being returnable to soil, and the fermentation can be carried out by using a conventionally known method. In addition, the fermentation condition for the shredded product is not particularly limited, but it is preferable to use an aerobic condition rather than an anaerobic condition. A fermented product obtained through fermentation under the aerobic condition is easily utilized for growing crops compared to a fermented product obtained through fermentation under the anaerobic condition. Note that the anaerobic condition in the present embodiment refers to a condition in which there is practically no free oxygen, and the aerobic condition refers to a condition in which there is free oxygen.

In addition, in the case of producing a compost by using a shredded product to which excretion have been attached, the compost of the present embodiment can be produced by attaching excretion to a shredded product and fermenting the shredded product to which excretion have been attached. Examples of the method for attaching excretion to the shredded product may include a method in which excretion are mixed into the shredded product and a method in which the shredded product is used as a bedding for domestic animals, and domestic animals are bred in the rearing area in which the shredded product is spread, thereby attaching excretion to the shredded product. The amount of the excretion to be attached to the bedding for domestic animals is not particularly limited and can be set as appropriate.

The compost of the present embodiment can be used for growing crops in the same manner as a conventional compost obtained by using woody feedstocks or the like. In addition, since plants of the genus Erianthus to be used for the compost of the present embodiment are easily cultivated and are also excellent in the growth efficiency, as mentioned above, the cost of the compost of the present embodiment is difficult to rise and the shortage of supply is unlikely to occur. In particular, since Erianthus arundinaceus can be produced with a high biomass quantity, the cost of the compost of the present embodiment using Erianthus arundinaceus is further difficult to rise and the shortage of supply is further unlikely to occur.

### EXAMPLES

The present invention will be described further specifically with reference to the following Examples, but the present invention is not limited to them.

### Example 1

Above ground parts (stems and leaves) of Erianthus arundinaceus in the withering and dying stage were harvested. The harvested Erianthus arundinaceus was dried and shredded using a sawdust powder making machine. The resulting shredded product was used as a bedding of Example 1. Note that the bulk density of the shredded product was 132.1 kg/m³. The bulk density was determined by performing measurement twice using a bulk density measuring apparatus MT-1000 (manufactured by SEISHIN ENTERPRISE Co., Ltd.), and then calculating the their average value. Note that the measurement of the bulk density was carried out in accordance with the ASTM standard D6393 (TEST-D Carr loose bulk density).

### Comparative Example 1

Wood derived from cedar was prepared. This wood was shredded using a sawdust powder making machine. The resulting shredded product (sawdust powder) was used as a bedding of Comparative Example 1. Note that the bulk density of the shredded product was 261.1 kg/m³. The bulk density was measured under the same condition as in Example 1.

### Rearing of Domestic Animals

The bedding of Example 1 was spread in a rearing area with 200 tsubo (about 661 m²) (hereinafter, referred to as a “first Erianthus zone”) in a poultry farm, and the rearing of Comparative Example 1 was spread in a rearing area with 212 tsubo (about 701 m²) (hereinafter, referred to as a “first control zone”) in the same poultry farm. Into the first Erianthus zone, 9696 broiler chicks (breed race: Cobb) were introduced, and 10898 broiler chicks (breed race: Cobb) were introduced into the first control zone. Broilers in the first Erianthus zone and the first control zone were bred for 50 days using a commercially available broiler feed (crude protein: 18.5% and metabolic energy: 3,200 kcal/kg). After 50 days, broilers that had grown in the first Erianthus zone and the first control zone were shipped out.

### Evaluation 1 (Evaluation of Concentration of Ammonia)

Over the four weeks after the introduction of chicks, the beddings in the first Erianthus zone and the first control zone were collected with an interval of one week, and the concentration of ammonia on the surface of each bedding was measured. The concentration of ammonia on the surface of the bedding was determined by performing measurement using a gas detector tube (GASTEC, manufactured by GASTEC CORPORATION) for three samples (bedding) taken at different locations, and then calculating their average value. The results are shown in FIG. 1.

As shown in FIG. 1, on the surface of the bedding in the first Erianthus zone (the bedding of Example 1), the concentration of ammonia was lower than that of the bedding in the first control zone (the bedding of Comparative Example 1) throughout the whole period of four weeks after the introduction of chicks. In particular, two weeks after the introduction of chicks, the bedding in the first Erianthus zone had a lower concentration of ammonia on the surface thereof compared to the bedding in the first control zone at a significance level of 5%, and three weeks after the introduction of chicks, the bedding in the first Erianthus zone had a lower concentration of ammonia on the surface thereof compared to the bedding in the first control zone at a significance level of 1%.

### Evaluation 2 (Evaluation of Footpad Dermatitis)

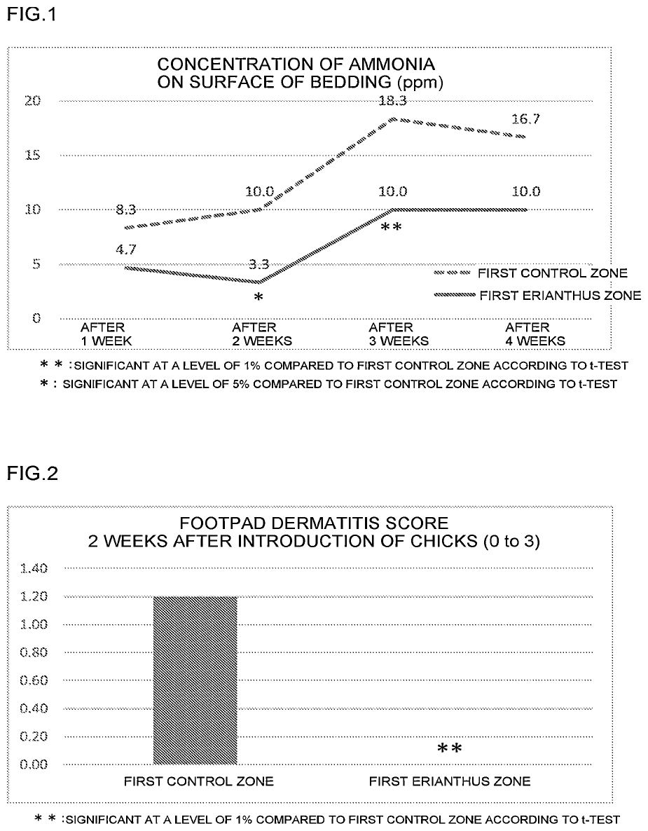

Over the two weeks after the introduction of chicks, five broilers in each of the first Erianthus zone and the first control zone were collected with an interval of one week, and evaluation was performed on footpad dermatitis. Evaluation of footpad dermatitis was carried out by visually confirming the soles of broiler toes and then calculating their average value of scores obtained in accordance with the following evaluation criteria. The results two weeks after the introduction of chicks are shown in FIG. 2.

### Evaluation Criteria

0: No lesion.
1: Localized fading of toe parts and blackened lesions only on the surface were seen.
2: Fading of toe parts and blackened lesions were seen, overall.
3: Bleeding, swelling, ulcers and scabs were seen.

Broilers in the first Erianthus zone had a lower average value of the scores compared to broilers in the first control zone throughout the whole period of two weeks after the introduction of chicks. In particular, broilers in the first Erianthus zone exhibited no footpad dermatitis at all throughout the whole period of two weeks after the introduction of chicks. And as shown in FIG. 2, in the two weeks after the introduction of chicks, the average value of the scores was lower than that of broilers in the first control zone at a significance level of 1%.

Footpad dermatitis is caused by a bacterial infection arising from excessive ammonia or moisture included in the bedding, and therefore, the results of Evaluation 2 (Evaluation of Footpad dermatitis) were consistent with the results of Evaluation 1 (Evaluation of Concentration of Ammonia).

### Evaluation 3 (Evaluation of Rearing Rate)

Over the fifty days after the introduction of chicks, the rearing rate of broilers in each of the first Erianthus zone and the first control zone was calculated. The rearing rate was calculated in accordance with the following equation (1). The results are shown in FIG. 3.

$$\begin{matrix}[ Equation 1 ] & \\ Rearing rate ( \% ) = \frac{( A - B )}{A} \times 100 & ( 1 )\end{matrix}$$

In the above equation (1), A represents the number of broilers that were introduced, and B represents the number of broilers that died.

As shown in FIG. 3, one week after the introduction of chicks, the rearing rate of broilers in the first Erianthus zone became higher than the rearing rate of broilers in the first control zone, and until 50 days after the introduction of chicks, the rearing rate of broilers in the first Erianthus zone was kept higher than the rearing rate of broilers in the first control zone. Fifty days after the introduction of chicks (at the time of broiler shipment), the rearing rate of broilers in the first Erianthus zone was higher than the rearing rate of broilers in the first control zone by 1% or more, resulting in a large difference in the proportion of broilers that could be shipped.

From the results of Evaluation 1 to Evaluation 2, it was understood that the bedding of Example 1 is less likely to leave ammonia on the surface of the bedding compared to the bedding of Comparative Example 1 and that the onset and progression of footpad dermatitis can be suppressed. In addition, from the results of Evaluation 3, it was understood that broilers bred in the rearing area in which the bedding of Example 1 was spread are less likely to die compared to the bedding of Comparative Example 1. In other words, it was understood that the bedding of Example 1 creates an environment more suited for growing domestic animals compared to the bedding of Comparative Example 1.

### Production of Compost

After the broiler shipment, the bedding in the first Erianthus zone (the bedding of Example 1) and the bedding in the first control zone (the bedding of Comparative Example 1) were each collected. To the beddings of Example 1 and Comparative Example 1, excretion of broilers were attached. Composts were produced by fermenting the collected beddings of Example 1 and Comparative Example 1. Production of the composts was carried out by placing each of the collected beddings into a compost production apparatus (KAGUYAHIME, manufactured by FUJIHIRA INDUSTRY CO., LTD.), stirring the beddings with an interval of two days or three days, and fermenting the beddings under an aerobic condition over about one and a half months.

### Evaluation 4 (Evaluation of Germination)

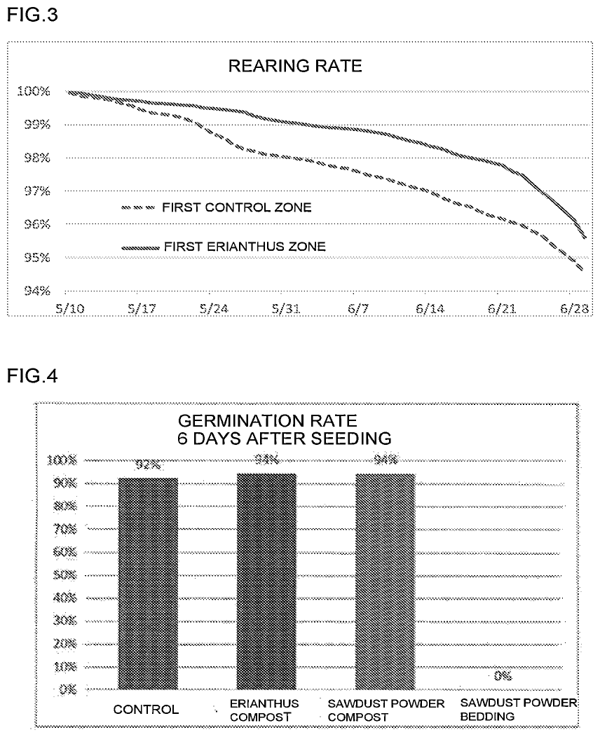

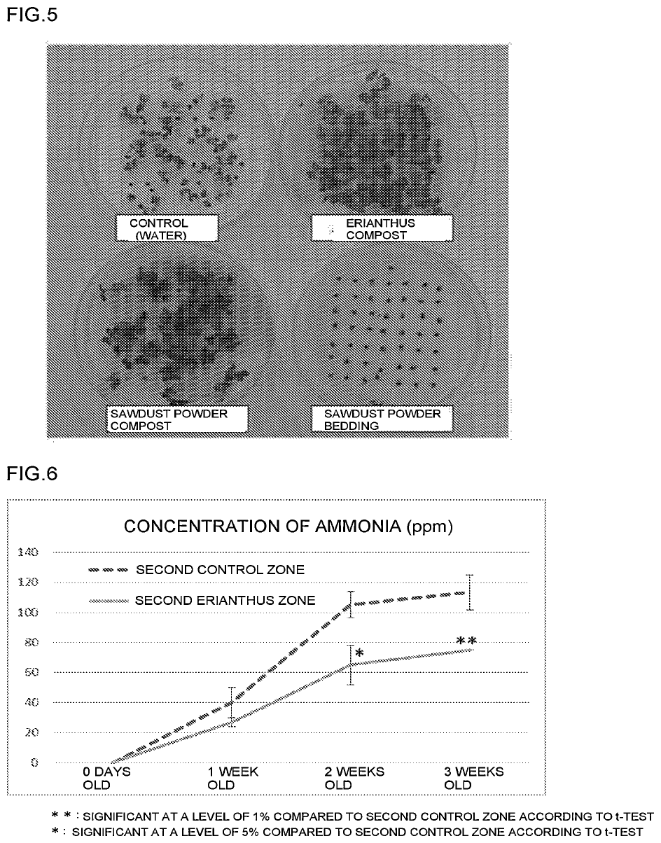

The compost obtained by fermenting the bedding of Example 1 (hereinafter, referred to as an “Erianthus compost”), the compost obtained by fermenting the bedding of Comparative Example 1 (hereinafter, referred to as a “sawdust powder compost”), and the bedding of Comparative Example 1 collected after the broiler shipment (hereinafter, referred to as a “sawdust powder bedding”) were each extracted with hot water, thereby acquiring extraction liquids. Each of the acquired extraction liquids was allowed to be absorbed by a sponge, and these sponges were seeded with Japanese mustard spinach seeds. In addition, as the control, water obtained by cooling the hot water that was not used for the extraction with hot water was allowed to be absorbed by a sponge, and the sponge was seeded with Japanese mustard spinach seeds. The germination rate six days after the seeding was calculated in accordance with the following equation (2). The results are shown in FIG. 4. In addition, a photograph of the germination state six days after the seeding is shown in FIG. 5.

$$\begin{matrix}[ Equation 2 ] & \\ Germination rate ( \% ) = \frac{C}{D} \times 100 & ( 2 )\end{matrix}$$

In the above equation (2), C represents the number of seeds germinated and D represents the number of seeds sown.

As shown in FIG. 4 and FIG. 5, Japanese mustard spinach seeds for which the extraction liquid of the Erianthus compost and the extraction liquid of the sawdust powder compost were used had higher germination rates compared to Japanese mustard spinach seeds for which water was used. In addition, Japanese mustard spinach seeds for which the extraction liquids of the Erianthus compost and the sawdust powder compost were used had the same germination rate. From these results, it was understood that the compost using the bedding of Example 1 can be used as a compost in the same way as the compost using the bedding of Comparative Example 1.

In addition, while the germination rate of Japanese mustard spinach seeds for which the extraction liquid of the sawdust powder bedding was used was 0%, the germination rates of Japanese mustard spinach seeds for which the extraction liquid of the Erianthus compost and the extraction liquid of the sawdust powder compost were used were both 94%. From these results, it was understood that, even if excretion were attached to the bedding, harmful substances contained in excretion that inhibit the growth of crops are decomposed through the fermentation of the bedding.

### Example 2

Above ground parts (stems and leaves) of Erianthus arundinaceus in the withering and dying stage were harvested, and made into a roll bale immediately after the harvesting for storage. After a certain period of time, a harvested product (above ground parts of Erianthus arundinaceus) was collected from the roll bale and this was used as the bedding of Example 2. Note that the bulk density of the harvested product was 96.1 kg/m³. The bulk density was determined by performing measurement twice using a bulk density measuring apparatus MT-1000 (manufactured by SEISHIN ENTERPRISE Co., Ltd.), and then calculating their average value thereof. Note that the measurement of the bulk density was carried out in accordance with the ASTM standard D6393 (TEST-D Carr loose bulk density).

### Comparative Example 2

Wood derived from cedar was prepared. This wood was shredded using a sawdust powder making machine. The resulting shredded product (sawdust powder) was used as a bedding of Comparative Example 2. Note that the bulk density of the shredded product was 199.9 kg/m³. The bulk density was measured under the same condition as in Example 2.

The bedding of Example 2 was spread in a rearing area with 200 tsubo (about 661 m²) (hereinafter, referred to as a “second Erianthus zone”) in a poultry farm, and the bedding of Comparative Example 2 was spread in a rearing area with 229 tsubo (about 757 m²) (hereinafter, referred to as a “second control zone”) in the same poultry farm. Into the second Erianthus zone, 9510 broiler chicks (breed race: Cobb) were introduced, and 10810 broiler chicks (breed race: Cobb) were introduced into the second control zone. Broilers in the second Erianthus zone and the second control zone were bred for 48 days using a commercially available broiler feed (crude protein: 18.5% and metabolic energy: 3,200 kcal/kg). After 48 days, broilers that had grown in the second Erianthus zone and the second control zone were shipped out.

### Evaluation 5 (Evaluation of Concentration of Ammonia)

Over the three weeks after the introduction of chicks, the beddings in the second Erianthus zone and the second control zone were collected with an interval of one week, and the concentration of ammonia on the surface of each bedding was measured. The concentration of ammonia on the surface of the bedding was determined by performing measurement using a gas detector tube (GASTEC, manufactured by GASTEC CORPORATION) for three samples (bedding) taken at different locations, and then calculating their average value. The results are shown in FIG. 6.

As shown in FIG. 6, on the surface of the bedding in the second Erianthus zone (the bedding of Example 2), the concentration of ammonia was lower than that of the bedding in the second control zone (the bedding of Comparative Example 2) over the three weeks after the introduction of chicks. In particular, two weeks after the introduction of chicks, the bedding in the second Erianthus zone had a lower concentration of ammonia on the surface thereof compared to the bedding in the second control zone at a significance level of 5%, and three weeks after the introduction of chicks, the bedding in the second Erianthus zone had a lower concentration of ammonia on the surface of the bedding compared to the bedding in the second control zone at a significance level of 1%.

### Evaluation 6 (Hardness)

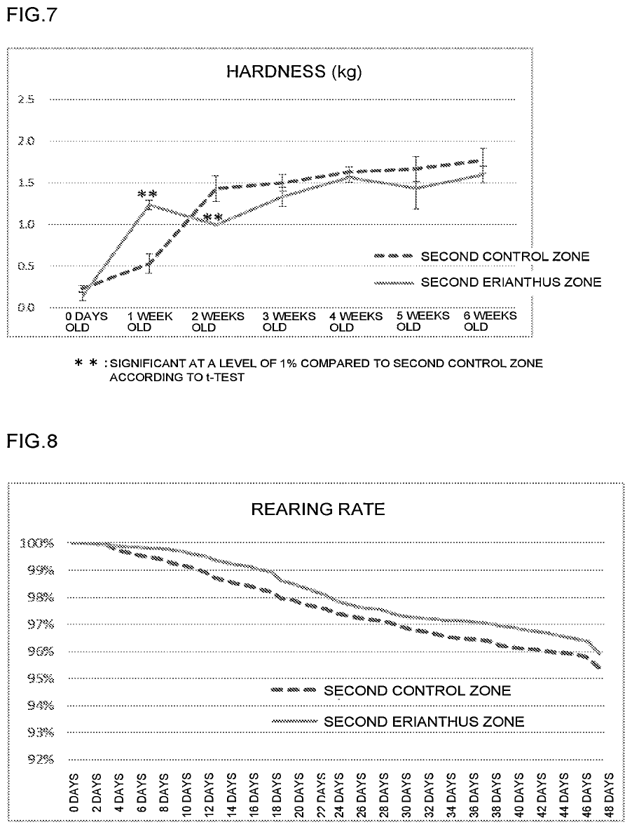

Over the six weeks after the introduction of chicks, for the beddings in the second Erianthus zone and the second control zone, the hardness was measured with a fruit hardness tester (KM type, manufactured by FUJIWARA SCIENTIFIC CO., LTD.). The hardness was determined by pressing the fruit hardness tester against the bedding in the vertical direction for measurement at three different locations and then calculating their average value. The results are shown in FIG. 7.

As shown in FIG. 7, the bedding in the second Erianthus zone (the bedding of Example 2) maintained a lower hardness compared to the bedding in the second control zone (the bedding of Comparative Example 2) over the second week to the sixth week after the introduction of chicks, and was thus able to maintain the hardness at a low level for a longer period of time.

### Evaluation 7 (Evaluation of Rearing Rate)

Over the forty-eight days after the introduction of chicks, the rearing rate of broilers in each of the second Erianthus zone and the second control zone was calculated. The rearing rate was calculated in accordance with the above equation (1). The results are shown in FIG. 8.

As shown in FIG. 8, four days after the introduction of chicks, the rearing rate of broilers in the second Erianthus zone became higher than the rearing rate of broilers in the second control zone, and until 48 days after the introduction of chicks, the rearing rate of broilers in the second Erianthus zone was kept higher than the rearing rate of broilers in the second control zone.

### Evaluation 8 (Feed Conversion Rate)

After the broiler shipment, the feed conversion rate (FCR) for broilers in each of the second Erianthus zone and the second control zone was calculated. The feed conversion rate was calculated in accordance with the following equation (3). Note that a lower feed conversion rate indicates that domestic animals are more likely to grow on less feed. The results are shown in FIG. 9.

$$\begin{matrix}[ Equation 3 ] & \\ Feed conversion rate ( \% ) = \frac{E}{F} \times 100 & ( 3 )\end{matrix}$$

In the above equation (3), E represents the amount of feed used (kg) and F represents the weight of shipment (kg).

As shown in FIG. 9, the feed conversion rate of broilers in the second Erianthus zone was lower than the feed conversion rate of broilers in the second control zone.

### Evaluation 9 (Production Score)

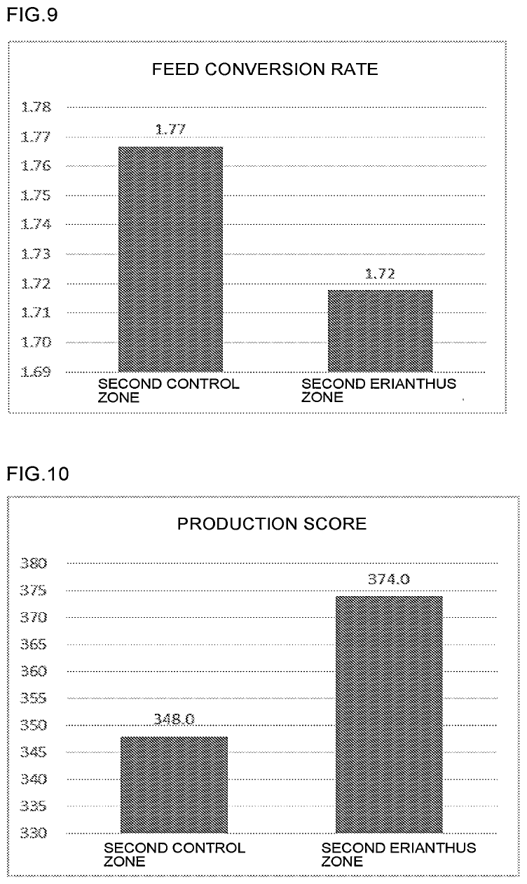

After the broiler shipment, the production score (PS) of broilers in each of the second Erianthus zone and the second control zone was calculated. The production score was calculated in accordance with the following equation (4). Note that a higher production score indicates that the productivity is higher (that is, the economic efficiency is excellent). The results are shown in FIG. 10.

$$\begin{matrix}[ Equation 4 ] & \\ Production score ( - ) = \frac{G \times H}{I \times J} \times 100 & ( 4 )\end{matrix}$$

In the above equation (4), G represents the average weight at the time of shipment (kg), H represents the rearing rate (%), I represents the feed conversion rate (%), and J represents the number of days of shipment (Days).

As shown in FIG. 10, the production score of broilers in the second Erianthus zone was higher than the production score of broilers in the second control zone.

From the results of Evaluation 5 to Evaluation 6, it was understood that the bedding of Example 2 is less likely to leave ammonia on the surface of the bedding and also has a lower hardness compared to the bedding of Comparative Example 2, thus making it easier for broilers to grow. In addition, as a result, the bedding of Example 2 improved the rearing rate, the feed conversion rate and the production score compared to the bedding of Comparative Example 2, as shown in Evaluations 7 to 9. In other words, it was understood that the bedding of Example 2 can create an environment more suited for growing domestic animals compared to the bedding of Comparative Example 2.

### Reference Evaluation 1 (Water Absorbing Capacity)

For each of 16 lots of shredded products of a plant of the genus Erianthus and 3 lots of sawdust derived from cedar, shredded under different conditions from each other, 1 lot of rice husks, 1 lot of sugar cane bagasse and 1 lot of shredded recycled paper (hereinafter, also referred to as “samples”), the bulk density was measured. Note that the bulk density was measured under the same condition as in Example 1. In addition, for the shredded products of a plant of the genus Erianthus, above ground parts (stems and leaves) were used.

Each sample, whose bulk density had been measured, was dried at 105° C. for 5 hours. About 5 g of each dried sample was added to triangular flasks, and about 200 g (about 200 ml) of Milli Q water was added to each of the triangular flasks. After the addition of Milli Q water, the mouths of the triangular flasks were covered with Parafilm in order to prevent moisture from being evaporated. Then, the triangular flasks were placed on a shaking incubator (TAITEC B⋅GR-200) and stored under conditions of 4° C. and 100 rpm for 24 hours. Subsequently, the contents of the triangular flasks were sieved through a stainless steel sieve (sieve opening: 90 μm and diameter: 20 cm), and sieved liquids were taken.

The amounts (g) of the sieved liquids taken were measured, and the water absorbing capacity of each sample was determined in accordance with the following equation (5). The results are shown in Table 1.

$$\begin{matrix}[ Equation 5 ] & \\ Water absorbing capacity ( \% ) = \frac{( K - L )}{M} \times 100 & ( 5 )\end{matrix}$$

In the above equation (5), K represents the amount (g) of Milli Q water added to the triangular flask, L represents the amount (g) of the sieved liquid taken, and M represents the amount (g) of the sample added to the triangular flask.

TABLE 1

| | Bulk | Water |
|---|---|---|
| | density | absorbing |
| Sample name | (kg/m³) | capacity (%) |
| Shredded product of plant of genus Erianthus 1 | 85 | 473.2 |
| Shredded product of plant of genus Erianthus 2 | 140 | 616.8 |
| Shredded product of plant of genus Erianthus 3 | 174 | 697.0 |
| Shredded product of plant of genus Erianthus 4 | 172 | 838.4 |
| Shredded product of plant of genus Erianthus 5 | 218 | 1,007.6 |
| Shredded product of plant of genus Erianthus 6 | 90 | 505.2 |
| Shredded product of plant of genus Erianthus 7 | 145 | 664.8 |
| Shredded product of plant of genus Erianthus 8 | 173 | 804.4 |
| Shredded product of plant of genus Erianthus 9 | 189 | 904.2 |
| Shredded product of plant of genus Erianthus 10 | 189 | 1,009.4 |
| Shredded product of plant of genus Erianthus 11 | 60 | 513.8 |
| Shredded product of plant of genus Erianthus 12 | 138 | 703.8 |
| Shredded product of plant of genus Erianthus 13 | 182 | 690.8 |
| Shredded product of plant of genus Erianthus 14 | 178 | 779.0 |
| Shredded product of plant of genus Erianthus 15 | 213 | 1,032.0 |
| Shredded product of plant of genus Erianthus 16 | 91 | 589.4 |
| Sawdust derived from cedar 1 | 162 | 569.6 |
| Sawdust derived from cedar 2 | 158 | 574.6 |
| Sawdust derived from cedar 3 | 157 | 587.2 |
| Shredded recycled paper | 57 | 410.2 |
| Rice husks | 120 | 404.4 |
| Sugar cane bagasse | 73 | 779.0 |

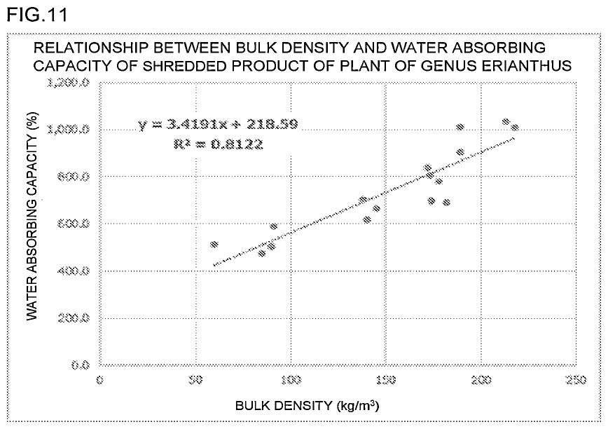

For each sample pertaining to the plant of the genus Erianthus, the relationship between the bulk density and the water absorbing capacity is shown in FIG. 11. When regression analysis was performed on the relationship between the bulk density and the water absorbing capacity for each sample shown in FIG. 11, the first regression formula represented by y=3.4191x+218.59 (wherein, x=bulk density (kg/m³) and y=water absorbing capacity (%)) was obtained and the coefficient of determination R² was 0.8122. From these results, for each sample pertaining to the plant of the genus Erianthus, it was understood that the bulk density and the water absorbing capacity are correlated.

By substituting the water absorbing capacity of the rice husk sample (404.4), which had the lowest water absorbing capacity among the samples shown in Table 1, for y in the first regression formula (y=3.4191x+218.59), the bulk density (x) of the shredded product of the plant of the genus Erianthus required to obtain the water absorbing capacity of the rice husk sample (404.4) was calculated to be 54.3 kg/m³. From this bulk density, it was found that, if the bulk density of the shredded of the plant of the genus Erianthus is set to 50 kg/m³ or more, preferably 55.0 kg/m³ or more, a water absorbing capacity that is equivalent to or greater than that of rice husks commonly used as beddings can be achieved.

### Reference Evaluation 2 (Cushioning Property)

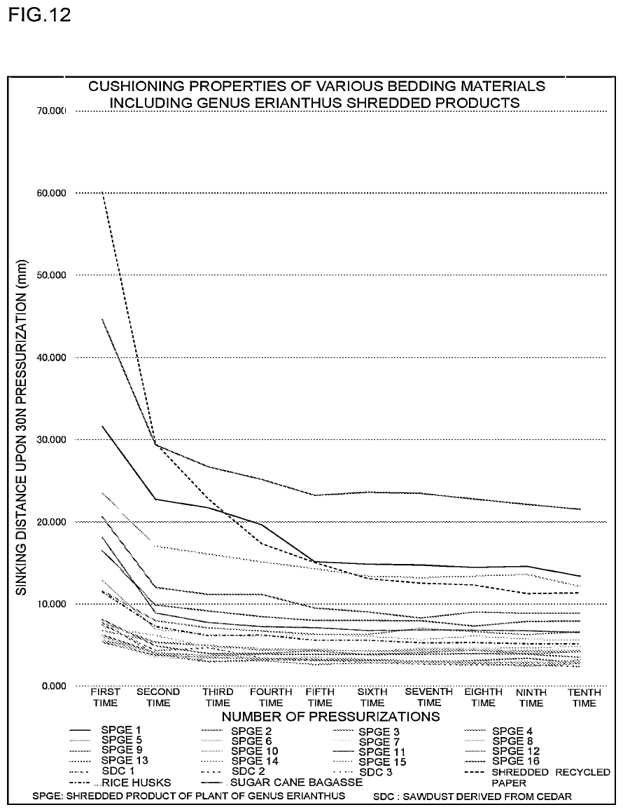

In glass tall beakers (PYREX (registered trademark) 1060-200 WS, outer diameter: 56 mm, height: 102 mm), 10.0 g of each sample, whose bulk density had been measured in Reference Evaluation 1, was taken. A load cell (AGS-XCL-1100N) was set up in the SHIMADZU table-top precision universal tester (AUTOGRAPH AGS-X 10kN), and a jig (thickness: 10 mm, diameter: 47 mm φ, length of shaft: 200 mm) was connected to the load cell. The tall beaker was placed under the jig and the jig was moved downward, and when it was visually confirmed that the jig came into contact with the sample interface in the tall beaker, that position was set to point 0. After that, the jig was pushed down at a speed of 5 mm/min, and the distance from point 0 to the jig (the sinking distance) at the time point where the pressure applied on the jig reached 30 N (3 kg) was measured. This operation was repeated 10 times, and the distance measured at the tenth time was defined as the cushioning degree representing the cushioning property. The results of the first to tenth measurements are shown in FIG. 12 and the cushioning degree is shown in Table 2.

TABLE 2

| | Bulk | Cushioning |
|---|---|---|
| | density | degree |
| Sample name | (kg/m³) | (mm) |
| Shredded product of plant of genus Erianthus 1 | 85 | 13.39 |
| Shredded product of plant of genus Erianthus 2 | 140 | 7.92 |
| Shredded product of plant of genus Erianthus 3 | 174 | 2.84 |
| Shredded product of plant of genus Erianthus 4 | 172 | 4.18 |
| Shredded product of plant of genus Erianthus 5 | 218 | 2.73 |
| Shredded product of plant of genus Erianthus 6 | 90 | 12.13 |
| Shredded product of plant of genus Erianthus 7 | 145 | 5.61 |
| Shredded product of plant of genus Erianthus 8 | 173 | 4.41 |
| Shredded product of plant of genus Erianthus 9 | 189 | 3.52 |
| Shredded product of plant of genus Erianthus 10 | 189 | 3.19 |
| Shredded product of plant of genus Erianthus 11 | 60 | 21.53 |
| Shredded product of plant of genus Erianthus 12 | 138 | 6.63 |
| Shredded product of plant of genus Erianthus 13 | 182 | 4.18 |
| Shredded product of plant of genus Erianthus 14 | 178 | 4.85 |
| Shredded product of plant of genus Erianthus 15 | 213 | 2.80 |
| Shredded product of plant of genus Erianthus 16 | 91 | 8.89 |
| Sawdust derived from cedar 1 | 162 | 2.39 |
| Sawdust derived from cedar 2 | 158 | 2.79 |
| Sawdust derived from cedar 3 | 157 | 3.02 |
| Shredded recycled paper | 57 | 11.36 |
| Rice husks | 120 | 5.14 |
| Sugar cane bagasse | 73 | 6.54 |

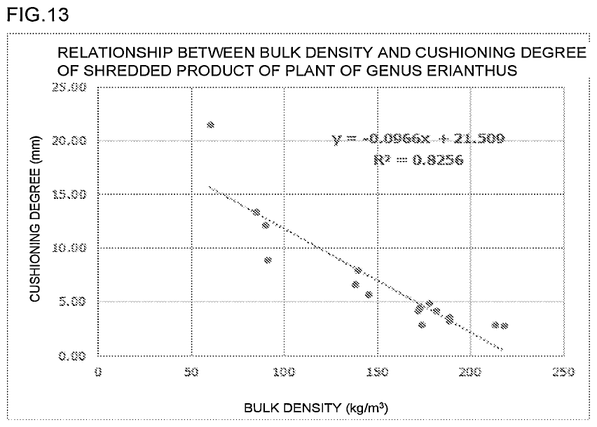

For each sample pertaining to the plant of the genus Erianthus, the relationship between the bulk density and the cushioning degree is shown in FIG. 13. When regression analysis was performed on the relationship between the bulk density and the cushioning degree for each sample shown in FIG. 13, the second regression formula represented by y=−0.0966x+21.509 (wherein, x=bulk density (kg/m³) and y=cushioning degree (mm)) was obtained and the coefficient of determination R² was 0.8256. From these results, for the plant of the genus Erianthus, it was understood that the bulk density and the cushioning degree are correlated.

By substituting the cushioning degree of the sample of sawdust derived from cedar 1 (2.39), which had the lowest cushioning degree among the samples shown in Table 1, for y in the second regression formula (y=−0.0966x+21.509), the bulk density (x) of the shredded product of the plant of the genus Erianthus required to obtain the cushioning degree of the sample of sawdust derived from cedar 1 (2.39) was calculated to be 197.9 kg/m³. From this bulk density, it was found that, if the bulk density of the shredded product of the plant of the genus Erianthus is set to 200 kg/m³ or less, preferably 195.0 kg/m³ or less, a cushioning degree that is equivalent to or greater than that of sawdust commonly used as beddings can be achieved.

Note that the tests of the above Reference Evaluations 1 and 2 were tests carried out based on the Report of Fuji Industrial Technology Support Center of Shizuoka Prefecture, No. 11 (2001), p. 17-24.

### Reference Evaluation 3 (Water Retaining Property)

For each of 8 lots of shredded products of a plant of the genus Erianthus and 3 lots of sawdust derived from cedar, shredded under different conditions from each other, 1 lot of rice husks, 1 lot of sugar cane bagasse and 1 lot of shredded recycled paper (hereinafter, also referred to as “samples”), the bulk density was measured. Note that the bulk density was measured under the same condition as in Example 1. In addition, for the shredded products of a plant of the genus Erianthus, above ground parts (stems and leaves) were used.

Each sample, whose bulk density had been measured, was dried at 105° C. for 5 hours. About 5 g of each dried sample was added to triangular flasks, and about 200 g (about 200 ml) of Milli Q water was added to each of the triangular flasks. After the addition of Milli Q water, the mouths of the triangular flasks were covered with Parafilm in order to prevent moisture from being evaporated. Then, the triangular flasks were placed on a shaking incubator (TAITEC B⋅GR-200) and stored under conditions of 4° C. and 100 rpm for 24 hours. Subsequently, the contents of the triangular flasks were sieved through a stainless steel sieve (sieve opening: 90 μm and diameter: 20 cm), and a residue on the sieve was collected.

The collected residue on the sieve was subjected to centrifugation at 3000 g for 15 min to remove a part of moisture contained in the residue on the sieve. The residue on the sieve from which a part of moisture had been removed (hereinafter, also referred to as a “wet residue”) was collected, and the amount (g) thereof was measured. By using the amount of the wet residue measured, the water retention degree of each sample was determined in accordance with the following equation (6). The results are shown in Table 3.

$$\begin{matrix}[ Equation 6 ] & \\ Water retention degree ( \% ) = \frac{( N - M )}{M} \times 100 & ( 6 )\end{matrix}$$

In the above equation (6), N represents the amount (g) of the wet residue, and M represents the amount (g) of the sample added to the triangular flask.

TABLE 3

| | Bulk | Water |
|---|---|---|
| | density | retention |
| Sample name | (kg/m³) | degree (%) |
| Shredded product of plant of genus Erianthus 17 | 85 | 210.4 |
| Shredded product of plant of genus Erianthus 18 | 140 | 314.6 |
| Shredded product of plant of genus Erianthus 19 | 172 | 200.8 |
| Shredded product of plant of genus Erianthus 20 | 218 | 255.2 |
| Shredded product of plant of genus Erianthus 21 | 173 | 232.9 |
| Shredded product of plant of genus Erianthus 22 | 60 | 224.9 |
| Shredded product of plant of genus Erianthus 23 | 138 | 207.9 |
| Shredded product of plant of genus Erianthus 24 | 178 | 206.6 |
| Sawdust derived from cedar 4 | 162 | 94.5 |
| Sawdust derived from cedar 5 | 158 | 92.7 |
| Sawdust derived from cedar 6 | 157 | 86.0 |
| Shredded recycled paper | 57 | 81.2 |
| Rice husks | 120 | 126.8 |
| Sugar cane bagasse | 73 | 167.4 |

As shown in Table 3, each sample pertaining to the plant of the genus Erianthus had a higher water retention degree compared to the other samples. From these results, it was understood that the samples pertaining to the plant of the genus Erianthus have higher water retaining properties compared to the other samples, regardless of the bulk density.

1. A method for reducing footpad dermatitis in domestic animals comprising:
rearing domestic animals on a bedding comprising a shredded product of a plant of a genus Erianthus,
wherein the shredded product has a bulk density of 50 kg/m³ or more.

2. The method according to claim 1, wherein the shredded product has a water retention degree of 200.8% or more.

3. The method according to claim 1, wherein the shredded product has a bulk density of 50 kg/m³ or more and 200 kg/m³ or less.

4. The method according to claim 1, a concentration of ammonia on a surface of the bedding at 2 weeks after rearing the domestic animals is lower than a concentration of ammonia on a surface of a bedding consisting of sawdust at 2 weeks after rearing the domestic animals at a significance level of 5%.

5. The method according to claim 1, a concentration of ammonia on a surface of the bedding at 2 weeks after rearing the domestic animals is lower than a concentration of ammonia on a surface of a bedding consisting of sawdust at 3 weeks after rearing the domestic animals at a significance level of 1%.

6. The method according to claim 1, wherein the domestic animals are chickens.

7. The method according to claim 1, wherein the plant of a genus Erianthus is Erianthus arundinaceus.

8. The method according to claim 1, wherein the shredded product comprises the stems and leaves of the plant of a genus Erianthus.

9. The method according to claim 1, wherein the shredded product comprises does not include the roots of the plant of a genus Erianthus.

10. The method according to claim 1, wherein the rearing of the domestic animals on the bedding is effective to reduce footpad dermatitis in the domestic animals.

11. The method according to claim 1, wherein the shredded product comprises an additional material selected from the group consisting of woody feedstocks, straw, rice husks, waste mushroom beds, tea grounds, pruned branches and leaves, bagasse, coffee grounds, water absorbing polymers, fully matured compost, recycled paper, gypsum board, porous substances, and mixtures thereof.

12. The method according to claim 1, wherein the shredded product consists of the shredded product of the plant of the genus Erianthus.
